(19) United States
(12) Patent Application Publication
(10) Pub. No.: US 2026/0059203 A1
(43) Pub. Date: Feb. 26, 2026

(54) IMAGE PROCESSING APPARATUS AND IMAGE PROCESSING METHOD

(71) Applicant: CANON KABUSHIKI KAISHA, Tokyo (JP)

(72) Inventor: ATSUSHI FUJITA, Tokyo (JP)

(21) Appl. No.: 19/298,019

(22) Filed: Aug. 12, 2025

(30) Foreign Application Priority Data
Aug. 21, 2024 (JP) 2024-139974

(51) Int. Cl. H04N 23/81; G06T 5/70; G06T 5/73; G06T 5/80

(52) U.S. Cl. CPC H04N 23/81; G06T 5/70; G06T 5/73; G06T 5/80

(57) ABSTRACT

Image processing apparatuses methods, and storage mediums are provided herein. Disclosed is at least one embodiment of an image processing apparatus that generates a RAW image file in consideration of the differences in capabilities between applications used for a development process. The apparatus applies image processing to a first RAW image to generate a second RAW image and generates a RAW image file that contains the second RAW image as a file of one of a plurality of types that include a first type and a second type. The apparatus varies a setting of the image processing between a case where a RAW image file of the first type is generated and a case where a RAW image file of the second type is generated.

### BACKGROUND

### Field of the Technology

The present disclosure relates to one or more embodiments of an image processing apparatus and an image processing method.

### Description of the Related Art

There are cases where image processing aimed at improving the image quality is applied to RAW-type image data obtained by an image sensor (hereinafter referred to as a “RAW image”), before the RAW image is stored in a RAW image file.

However, some information is lost as a result of applying image processing. Japanese Patent Laid-Open No. 2021-114265 discloses a technology for improving, at the time of a development process, the image quality of a RAW image to which image processing was applied.

However, the capability of improving the image quality at the time of a development process differs depending on an application that is used for the development process.

### SUMMARY

One or more embodiments of the present disclosure provide an image processing apparatus and an image processing method that may generate a RAW image file in consideration of the differences in capabilities between applications used for a development process.

According to one or more aspects of the present disclosure, there is provided one or more embodiments of an image processing apparatus comprising: one or more processors that operate to: apply image processing to a first RAW image to generate a second RAW image; generate a RAW image file that contains the second RAW image as a file of one of a plurality of types that include a first type and a second type; and control an operation of the image processing, wherein the control varies a setting of the image processing between a case where a RAW image file of the first type is generated and a case where a RAW image file of the second type is generated.

According to one or more other aspects of the present disclosure, there is provided one or more embodiments of an image processing apparatus comprising: one or more processors that operate to: obtain a RAW image file; and apply a development process to a RAW image contained in the RAW image file, wherein the one or more processors vary the development process that is applied to the RAW image according to a type of RAW image file.

According to one or more further aspects of the present disclosure, there is provided one or more embodiments of an image processing method comprising: generating a second RAW image by applying image processing on a first RAW image; generating a RAW image file of one of a plurality of types that include a first type and a second type, the RAW image file containing the second RAW image; and varying a setting of the image processing between a case where a RAW image file of the first type is generated and a case where a RAW image file of the second type is generated in the generating of the RAW image file.

According to one or more additional aspects of the present disclosure, there is provided one or more embodiments of an image processing method comprising: obtaining a RAW image file; and applying a development process to a RAW image contained in the RAW image file, wherein the applying varies the development process according to a type of the RAW image file.

According to one or more further aspects of the present disclosure, there is provided one or more embodiments of a non-transitory computer-readable medium that stores a program for causing a computer to execute the image processing an image processing method comprising: generating a second RAW image by applying image processing on a first RAW image; generating a RAW image file of one of a plurality of types that include a first type and a second type, the RAW image file containing the second RAW image; and varying a setting of the image processing between a case where a RAW image file of the first type is generated and a case where a RAW image file of the second type is generated in the generating of the RAW image file.

According to one or more additional aspects of the present disclosure, there is provided one or more embodiments of a non-transitory computer-readable medium that stores a program for causing a computer to execute an image processing method comprising: obtaining a RAW image file; and applying a development process to a RAW image contained in the RAW image file, wherein the applying varies the development process according to a type of the RAW image file.

According to other aspects of the present disclosure, one or more additional image processing apparatuses, one or more additional image processing methods, and one or more image processing storage mediums are discussed herein. Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing at least one embodiment example of a functional configuration of an image capture apparatus that is an example of at least one image processing apparatus according to one or more embodiments of the present disclosure.

FIG. 2 is a diagram showing an example of at least one embodiment of a configuration in which a first RAW image is processed by an external apparatus in accordance with one or more aspects of the present disclosure.

FIG. 3 is a block diagram showing an example of at least one embodiment of a functional configuration of a general-purpose computer that may realize an image processing system in FIG. 2 in accordance with one or more aspects of the present disclosure.

FIG. 4 is a flowchart showing at least one embodiment of a mode of a generation process of a RAW image file and a development process of the generated RAW image file in accordance with one or more aspects of the present disclosure.

FIG. 5 is a flowchart showing at least one embodiment of a series of processing related to generation and development processes of a RAW image file of a manufacturer-specific type in a case where the RAW image file is to contain a first RAW image in accordance with one or more aspects of the present disclosure.

FIG. 6 is a flowchart related to at least one embodiment of operations of a dedicated application for executing a development process in accordance with one or more aspects of the present disclosure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

One or more embodiments of the present disclosure will be described below in detail with reference to the accompanying drawings. Note that the following embodiments do not limit the scope of the claims. In addition, although a plurality of features are described in the one or more embodiments, not all of them are necessarily essential, and the features may be suitably combined. Furthermore, in the accompanying drawings, the same reference numerals are assigned to identical or similar configurations, and a redundant description thereof is omitted.

Note that at least one image capture apparatus that is an example of an image processing apparatus according to the present disclosure will be described below. However, the image capture function is not essential, and may be implemented by any electronic device that includes one or more calculation circuits or processors. Examples of such an electronic device or devices include computer devices (such as personal computers, tablet computers, media players, and PDAs), smartphones, smartwatches, game consoles, robots, drones, drive recorders, and the like. Note that these are exemplary, and the image processing apparatus may be another electronic device.

### Configuration and Functions of Embodiment(s) of an Image Capture Apparatus

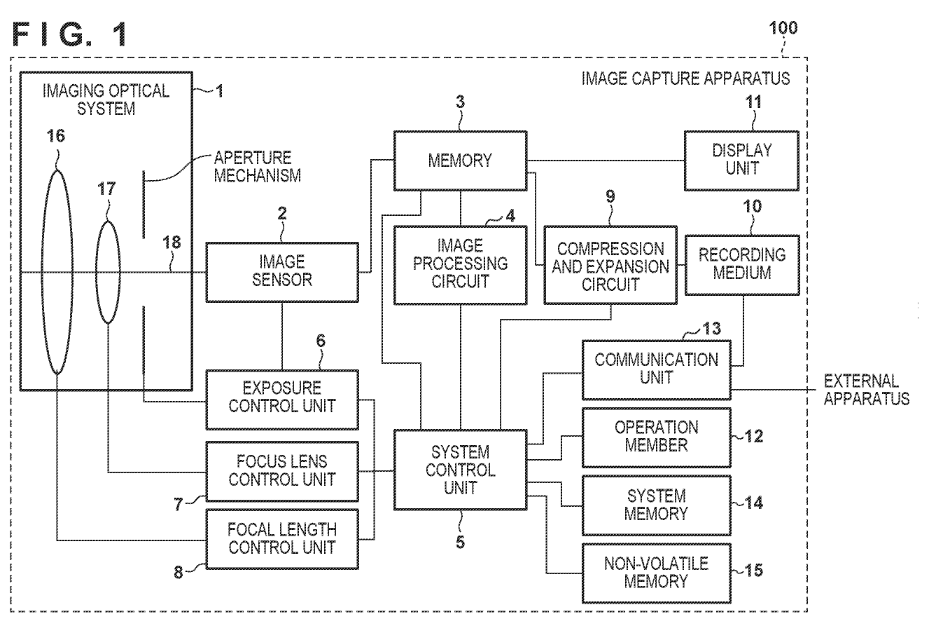

The configuration and functions of an image capture apparatus 100 that is an example of at least one embodiment of an image processing apparatus according to the present disclosure will be described with reference to FIG. 1.

The image capture apparatus 100 may communicate with an external apparatus (not illustrated) via a communication unit 13. The image capture apparatus 100 may transmit, for example, an image file recorded in a recording medium 10, an image file generated by a compression and expansion circuit or processor 9, and the like to the external apparatus.

An imaging optical system 1 includes a plurality of lens groups and an aperture mechanism 18. The plurality of lens groups include, for example, a zoom lens 16 and a focus lens 17. The imaging optical system 1 forms a subject optical image on the image capture surface of an image sensor 2.

The image sensor 2 converts the subject image that has passed through the imaging optical system 1 into electrical signals. The image sensor 2 may be, for example, a CCD or CMOS image sensor. In at least one embodiment, the image sensor 2 includes an A/D converter that converts analog signals into digital signals, and is capable of outputting a digital-type RAW image. Note that a configuration may also be adopted in which the image sensor 2 does not include an A/D converter, and A/D conversion is performed outside the image sensor 2 (for example, by an image processing circuit or processor 4). The image sensor 2 has a pixel array in which a plurality of pixels are arranged two-dimensionally. The pixel array is provided with a primary-color Bayer array color filter, for example. The subject optical image formed on the image capture surface by the imaging optical system 1 is photoelectrically converted into pixel signals (hereinafter, analog image signals) by the plurality of pixels of the image sensor 2. The image sensor 2 performs A/D conversion on the analog image signals to generate a RAW image and stores the generated RAW image in a memory 3.

The memory 3 stores images (including sound in a case of a moving image) generated by the image sensor 2 and images to be displayed on a display unit 11. The memory 3 also stores an image that is being processed by the compression and expansion circuit or processor 9 or the image processing circuit or processor 4, processed images, and the like. The memory 3 has a sufficient storage capacity to store a predetermined number of still images and moving images of a predetermined duration (including sound).

The image processing circuit or processor 4 applies, to an image stored in the memory 3, various types of image processing in accordance with a purpose. Examples of image processing that may be applied by the image processing circuit or processor 4 include preprocessing, color interpolation processing, correction processing, detection processing, data processing, and the like. Note that these are examples of image processing that may be performed by the image processing circuit or processor 4, and do not limit image processing that may performed by the image processing circuit or processor 4. A RAW image to which image processing was applied by the image processing circuit or processor 4 is stored in the memory 3.

In addition, image processing that is applied to an image by the image processing circuit or processor 4 also includes image processing for generating evaluation values or signals used by a system control unit 5 to perform automatic exposure control (AE) and automatic focus detection (AF). The image processing circuit or processor 4 may, for example, calculate brightness information of a specified region in an image as an evaluation value for AE. In addition, for example, in a case where the image sensor 2 is capable of outputting an image for focus detection, the image processing circuit or processor 4 may generate a signal to be used for phase-difference detection AF based on an image for focus detection, and calculate a defocus amount using a known method. The image processing circuit or processor 4 supplies evaluation values and signals for AE and AF to the system control unit 5.

The system control unit 5 is a control unit constituted by at least one processor and/or at least one circuit, and performs overall control of the image capture apparatus 100 collectively. The system control unit 5 controls operations of parts of the image capture apparatus 100 and realizes functions of the image capture apparatus 100 by loading a program recorded in a non-volatile memory 15 to a system memory 14 and executing the program. Processing to be described later with reference to the flowcharts is also executed by the system control unit 5.

The system control unit 5 executes AE and AF based on evaluation values generated by the image processing circuit or processor 4. Specifically, the system control unit 5 determines exposure conditions (such as an aperture value, a shutter speed, and sensitivity) on which a focus detection region is properly exposed, based on the evaluation value for AE. Then, based on the determined exposure conditions, the system control unit 5 causes an exposure control unit 6 to drive the aperture mechanism 18, and also controls operations of the image sensor 2. The system control unit 5 causes a focus lens control unit 7 to drive the focus lens 17 based on the evaluation value for AF calculated by the image processing circuit or processor 4 or a defocus amount, thereby performing AF for bringing the imaging optical system 1 into focus on a subject.

The system control unit 5 causes a focal length control unit 8 to drive the zoom lens 16, thereby changing the field of view of the imaging optical system 1, as one of processes performed in response to an operation of an operation member 12.

The system control unit 5 also controls storage, readout, and deletion of data with respect to the recording medium 10.

The system control unit 5 also functions as generating means for generating a RAW image file that includes a RAW image. The system control unit 5 temporarily stores the generated RAW image file in the memory 3, and then stores the RAW image file in the recording medium 10.

The system control unit 5 is capable of generating RAW image files of a plurality of file types. A file type is specified by the extension of a file name. In addition, in the present disclosure, a RAW image refers to image data that has not subjected to one or more of a plurality of types of image processing that depend on a device that captured the RAW image (here, the image capture apparatus 100).

Examples of image processing that depends on an image capture device may include:

processing for correcting properties of the image sensor and the imaging optical system

demosaic (debayer) processing

pixel interpolation (defective pixel correction) processing

white balance adjustment

edge enhancement processing

gamma processing

These are exemplary, and may include other processing.

In addition, image processing for improving the image quality that is performed by the image processing circuit or processor 4 may or may not be applied to a RAW image to be stored in a RAW image file. Hereinafter, a RAW image to which image processing for improving image quality has not been applied is referred to as a “first RAW image”, and a RAW image to which image processing for improving the image quality has been applied is referred to as a "second RAW image”. A RAW image file generated by the system control unit 5 may store one of or both the first RAW image and the second RAW image.

The system control unit 5 generates a RAW image file of at least one file type that is based on user settings, among a plurality of file types that may be used for generating RAW image files. A type of RAW image (at least one of a first RAW image and a second RAW image) stored in a RAW image file to be generated may or may not depend on a file type. For example, the file type may be a file type that may store both the first RAW image and the second RAW image, or may be a file type that may store only one of them.

The exposure control unit 6 drives the aperture mechanism 18 of the imaging optical system 1 in accordance with an instruction from the system control unit 5. The exposure control unit 6 also adjusts a drive timing and gain of the image sensor 2 in accordance with an instruction from the system control unit 5.

The focus lens control unit 7 drives the focus lens 17 in the optical axis direction of the imaging optical system 1 to control the position of the focus lens 17, in accordance with an instruction from the system control unit 5. Accordingly, the imaging optical system 1 may be focused on the subject.

The focal length control unit 8 drives the zoom lens 16 accordance with an instruction from the system control unit 5. Accordingly, the focal length (field of view) of the imaging optical system 1 is changed.

The compression and expansion circuit or processor 9 reads an image stored in the memory 3 and encodes and decodes the image in accordance with a predetermined encoding scheme, to perform compression and expansion processing of the image, respectively. In addition, the compression and expansion circuit or processor 9 has a function of generating an image file that stores encoded data. The compression and expansion circuit or processor 9 may comply with a plurality of encoding schemes for both a still image and a moving image. Encoded data, an image file, and decoded data generated by the compression and expansion circuit or processor 9 are stored in the memory 3.

The compression and expansion circuit or processor 9 stores, in the recording medium 10, an image file stored in the memory 3 in accordance with an instruction from the system control unit 5. In addition, decoded data stored in the memory 3 may be converted into image data to be displayed by the image processing circuit or processor 4, and displayed by the display unit 11.

The display unit 11 displays image data that is stored in the memory 3 and is to be displayed, on a display device of the image capture apparatus 100, an external display device, or the like.

The operation member 12 includes one or more input devices operable by the user, such as a switch, buttons, or a touch panel. Upon detecting an operation performed on the operation member 12, the system control unit 5 executes processing corresponding the detected operation. Note that the touch panel may be integrally formed with the display device of the image capture apparatus 100 or with an external display device.

The communication unit 13 is a communication interface to an external apparatus and complies with one or more wired and wireless communication standards. The system control unit 5 may transmit an image file recorded on the recording medium 10, encoded data generated by the compression and expansion circuit or processor 9, and the like, to the external apparatus via the communication unit 13.

The system memory 14 is, for example, a RAM. The system memory 14 temporarily stores a program to be executed by the system control unit 5, constants and variables necessary for executing the program, settings of the image capture apparatus 100, and the like.

The non-volatile memory 15 may be electrically erasable and recordable, such as an EEPROM. The non-volatile memory 15 stores specific information of the image capture apparatus 100, user settings, GUI data, programs to be executed by the system control unit 5, and the like.

The above second RAW image may be generated by the image capture apparatus 100 or a device separate from the image capture apparatus 100. In addition, a development process of a RAW image may be executed by the image capture apparatus 100 or an apparatus separate from the image capture apparatus 100.

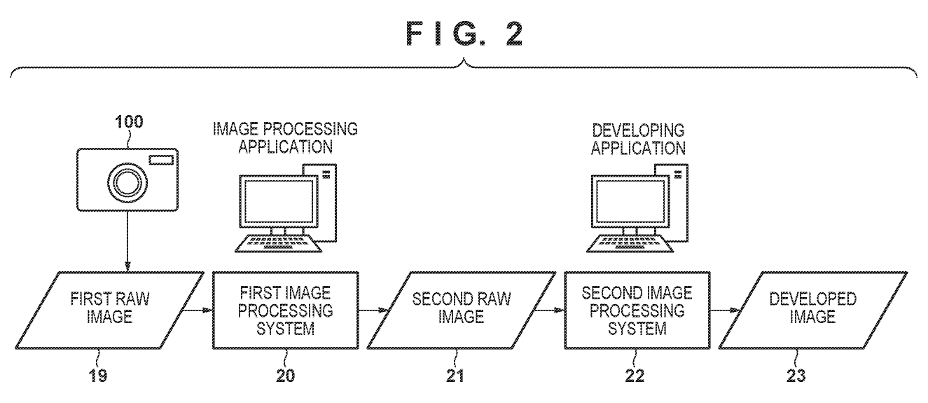

FIG. 2 is a diagram schematically showing at least one embodiment example of a series of image processing in a case where the image capture apparatus 100 generates a RAW image file that contains a first RAW image and does not contain a second RAW image, and generating and development processes of a second RAW image are performed by devices separate from the image capture apparatus 100. In FIG. 2, processing for generating a second RAW image based on a first RAW image and processing for applying a development process to the second RAW image are performed by different apparatuses (image processing systems), but may be performed by a single apparatus.

In FIG. 2, a first image processing system 20 and a second image processing system 22 may each be realized, for example, by an information processing apparatus such as a personal computer executing an image processing application.

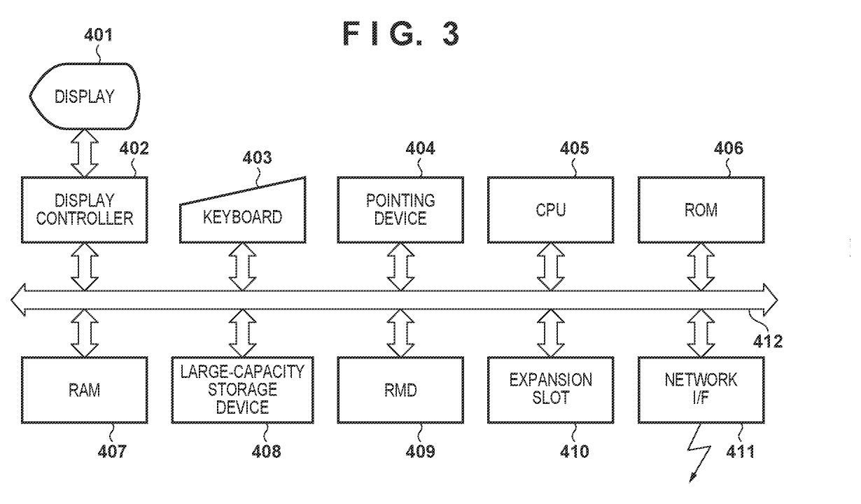

FIG. 3 is a block diagram showing an example of the functional configuration of an information processing apparatus that may be used as each of the first image processing system 20 and the second image processing system 22 in FIG. 2.

A display 401 is, for example, a liquid crystal display (LCD), and displays a screen provided by a program (OS and an application program) that is being executed by a CPU 405, and the like.

A display controller 402 includes a video RAM (VRAM), and controls what is displayed on the display 401.

A keyboard 403 and a pointing device 404 are examples of an input device operable by the user. The user may input characters and instructions to the information processing apparatus by performing an operation on the keyboard 403 and the pointing device 404, and may also perform an operation on GUI components such as icons and buttons included in the screen displayed on the display 401.

The CPU 405 realizes later-described operations of the image processing system by loading a program stored in a ROM 406 to a RAM 407 and executing the program.

The ROM 406 stores a program to be executed by the CPU 405, various parameters and setting values, and the like. The ROM 406 may be electrically rewritable. The RAM 407 is used as a work area when the CPU 405 executes various programs, a buffer for various types of data, or the like.

A large-capacity storage device 408 and a removable media drive (RMD) 409 are external storage apparatuses. The large-capacity storage device 408 may be a hard disk drive (HDD), a solid-state drive (SSD), or the like. The RMD 409 is an apparatus that reads and writes data from and to a removable recording medium such as a memory card, or loads data to the removable recording medium.

Note that programs for realizing various functions provided by a computer apparatus, as well as an OS, application programs such as a web browser, data, libraries, and the like are stored in one of or both the ROM 406 and the large-capacity storage device 408 according to intended usage.

Various expansion boards such as a video capture board and a sound board may be mounted to an expansion slot 410.

A network interface 411 is an interface for connecting the information processing apparatus to a local network or an external network. The network interface 411 complies with one or more wired and wireless communication standards.

In addition to the network interface 411, the information processing apparatus may include communication interfaces that comply with various standards such as USB, HDMI (registered trademark), and Bluetooth (registered trademark) for connection with external apparatuses.

A bus 412 is constituted by an address bus, a data bus, and a control bus, and connects the aforementioned functional blocks.

Note that the first image processing system 20 and the second image processing system 22 may each be any electronic device that may execute an application program, such as a smartphone or a tablet.

What will be described below as operations of each of the first image processing system 20 and the second image processing system 22 is realized by the CPU 405 of the first image processing system 20 or the second image processing system 22 executing application programs stored in the ROM 406 or the large-capacity storage device 408.

First, operations of the first image processing system 20 will be described. The first image processing system 20 obtains a RAW image file containing a first RAW image 19, which has been generated by the image capture apparatus 100. The first image processing system 20 may obtain the RAW image file, for example, from the image capture apparatus 100 through communication with the network I/F 411 and the communication unit 13, or from the recording medium 10 mounted to the RMD 409.

The first image processing system 20 performs image processing for improving the image quality on the first RAW image 19 to generate a second RAW image 21. The first image processing system 20 then generates a RAW image file containing the second RAW image 21, and stores the RAW image file, for example, in the large-capacity storage device 408. The image processing that is performed by the first image processing system 20 on a first RAW image may or may not be the same as image processing that is performed by the image processing circuit or processor 4 of the image capture apparatus 100 on a first RAW image.

The second image processing system 22 obtains the RAW image file containing the second RAW image 21 from the first image processing system 20, for example, through communication with the first image processing system 20 via the network I/F 411. The second image processing system 22 performs a development process on the second RAW image 21 to generate a developed image 23. The second image processing system 22 stores the generated developed image 23, for example, in the large-capacity storage device 408, and transmits the developed image 23 to an external apparatus via the network I/F 411. The development process at least includes image processing that depends on an image capture device, and may include image processing that does not depend on the image capture device.

Examples of the image processing that does not depend on an image capture device may include:

exposure correction processing

tone correction processing

sharpness correction processing

retouching (image editing) processing

color space conversion processing

Encoding processing

scaling or cropping processing

These are exemplary, and may include other processing.

Since processing that depends on an image capture device has been completed, the developed image 23 may be used by various devices. The developed image 23 is of a general-purpose image file type such as JPEG, HEIF, or TIFF.

In one or more embodiments of the present disclosure, in an apparatus that generates a second RAW image (the image capture apparatus 100 or the first image processing system 20), different image processing for improving the image quality is performed on a first RAW image according to a type of RAW image file to be generated. Here, noise reduction processing will be described as a typical example of image processing for improving the image quality. However, image processing for improving the image quality of a first RAW image may include one or more other types of image processing such as processing for correcting the effect of aberration of an imaging optical system, demosaic (debayer) processing, and the like.

Types of RAW image file may be roughly classified into a general-purpose type represented by DNG and a type specific to the manufacturer of an image capture apparatus. The data structure of a RAW image file of a manufacturer-specific type and details of data stored therein are not available to the public. For this reason, it is envisioned that a RAW image file of a manufacturer-specific type is basically processed by a development process application (dedicated application) provided by the manufacturer. Although there is a general-purpose development process application that supports a RAW image file of a manufacturer-specific type, it is not necessarily possible to use all the information contained in such a RAW image file of a manufacturer-specific type. Moreover, the extent to which information contained in a RAW image file of a manufacturer-specific type may be used may vary depending on a general-purpose development process application.

On the other hand, it is envisioned that a general-purpose type RAW image file is processed using a general-purpose development process application (general-purpose application). In addition, at the time of generation of a RAW image file, it is not possible to specify capabilities of a general-purpose application for performing a development process on the RAW image file. For this reason, information contained in a general-purpose type RAW image file is smaller in amount or less detailed than information contained in a manufacturer-specific type RAW image file.

Therefore, the quality of the developed image 23 generated based on a RAW image file particularly using a general-purpose application significantly depends on the capabilities of the general-purpose application. For this reason, in at least one embodiment, in order to suppress the influence that the capabilities of the general-purpose application for applying a development process has on the image quality of the developed image 23, image processing that is applied to the first RAW image is controlled in accordance with a type or file type of RAW image file to be generated.

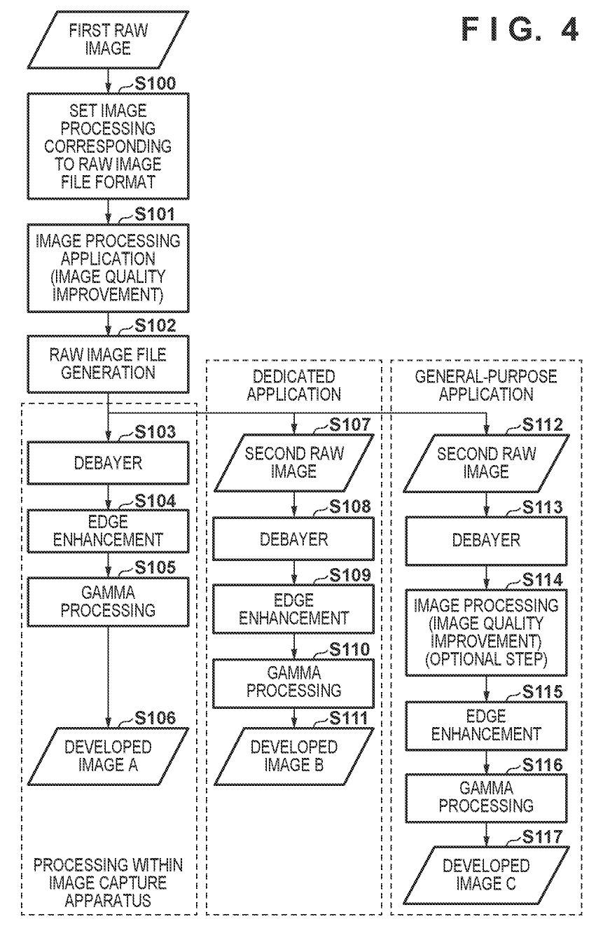

FIG. 4 is a flowchart showing a plurality of examples of a process of applying image processing for improving the image quality to a first RAW image and then generating a developed image. Here, cases where a development process is performed by the image capture apparatus 100, where a development process is performed by an external apparatus using a dedicated application, and where a development process is performed by an external apparatus using a general-purpose application are illustrated. FIG. 4 illustrates demosaic processing, edge enhancement processing, and gamma processing as common development processes, but the above various types of processing such as defective pixel correction and white balance adjustment may also be performed.

Steps S100 to S106 represent processing that is executed by the image capture apparatus 100.

In step S100, the system control unit 5 performs setting of image processing to be applied to a first RAW image by the image processing circuit or processor 4, in accordance with a type of RAW image file to be generated. The relationship between a type of RAW image file and setting of image processing may be stored in the non-volatile memory 15 in advance. Note that this relationship may be changeable by the user. The system control unit 5 varies image processing settings between a file type designed for a development process that is performed using a dedicated application or by the image processing circuit or processor 4 and a file type designed for a development process that is performed using a general-purpose application. The settings in step S100 will be described later in detail.

In step S101, the image processing circuit or processor 4 applies image processing for improving the image quality to the first RAW image in accordance with the content set in step S100, and generates a second RAW image. As an example, the image processing circuit or processor 4 applies noise reduction processing to the first RAW image. The noise reduction processing may be performed using any known method. For example, noise reduction processing may use a trained neural network, or may use a spatial low-pass filter.

In step S102, the system control unit 5 generates a RAW image file of a file type corresponding to the settings and stores the file in the recording medium 10. Here, it is assumed that the system control unit 5 generates a RAW image file that contains the second RAW image regardless of the file type, but the system control unit 5 may generate a RAW image file that does not contain the second RAW image.

In addition, here, it is assumed that determination is performed as to whether or not to store the first RAW image in a RAW image file to be generated, in accordance with the type of the RAW image file. Specifically, the system control unit 5 stores the first RAW image in a RAW image file that is generated as a manufacturer-specific type (first type) file, and does not store the first RAW image in a RAW image file that is generated as a general-purpose type (second type) file. Note that it is not necessary to store the first RAW image in a RAW image file that is generated as a first type file.

The execution of step S102 and the execution of subsequent steps (steps S103, S107, and S112) do not need to be temporally continuous.

In steps S103 to S105, the image processing circuit or processor 4 executes a development process on the second RAW image stored in the RAW image file generated in step S102. First, in step S103, the image processing circuit or processor 4 performs demosaic processing on the second RAW image. Demosaic processing is processing for interpolating the values of color components that are not present in the pixels constituting a RAW image, based on the values of near pixels, such that each of the pixels has RGB color components. In at least one, the image sensor 2 has a primary-color Bayer array color filter, and thus demosaic processing is also referred to as debayer processing. After debayer processing, the image processing circuit or processor 4 converts the signal type of the pixels from RGB into YCrCb.

In step S104, the image processing circuit or processor 4 performs edge enhancement processing on brightness components Y of the image subjected to debayer processing, to improve the sharpness of the image.

In step S105, the image processing circuit or processor 4 performs gamma processing on the image subjected to edge enhancement. Gamma processing is also called gradation correction processing, and is processing for adjusting gradation variation (brightness and contrast) of the image. The image processing circuit or processor 4 stores the image subjected to gamma processing in the memory 3.

In step S106, the compression and expansion circuit or processor 9 applies, as necessary, encoding processing depending on a preset type of developed image to the image subjected to gamma processing and stored in the memory 3, and generates a developed image A. The developed image A is of a general-purpose image file type such as JPEG, HEIF, or TIFF. The compression and expansion circuit or processor 9 stores the developed image A in the recording medium 10.

Steps S107 to S111 represent a development process that is applied to the second RAW image stored in the RAW image file, using a dedicated application that is provided by the manufacturer of the image capture apparatus 100 and is executed by the second image processing system 22 in FIG. 2, for example.

In addition, steps S112 to S117 represent a development process that is applied to the second RAW image stored in the RAW image file, using a general-purpose application that is executed by the second image processing system 22 in FIG. 2, for example. Step S114 represents a case where the general-purpose application is capable of executing image processing for improving the image quality as a portion of the development process. Whether or not to execute step S114 depends on the general-purpose application.

Note that steps S107 and S112, in which the second RAW image to which the development process is to be applied is extracted from the RAW image file, are described as a portion of the development process for convenience, but are not precisely included in the development process.

Usually, a development process that is performed using a developing application is executed in accordance with an interactive operation through a GUI screen provided by the application. Therefore, processing in the development process performed using the dedicated application and the general-purpose application may be performed in any order and any number of times. That is to say, the user may adjust parameters for each process while repeatedly setting the processing and confirming the result of the setting via a GUI screen provided by the development process application. When an instruction to store the developed image is given from the user, the CPU 405 generates a developed image based on the parameters at that point in time, and stores the image, for example, in the large-capacity storage device 408 (steps S111 and S117).

The debayer processing in step S108, the edge enhancement processing in step S109, and the gamma processing in step S110, which are executed using a dedicated application, use the same algorithm as the image processing circuit or processor 4 in order to suppress the difference from the developed image obtained by the image capture apparatus 100.

On the other hand, a specific technique for each of the debayer processing in step S113, the edge enhancement processing in step S115, and the gamma processing in step S116, which are executed using a general-purpose application, may differ for each application. Therefore, a developed image B generated using the dedicated application and a developed image C generated using the general-purpose application may be different even for the same second RAW image stored in the RAW image file.

Here, a specific example related to settings of image processing depending on the file type in step S100 will be described. There are cases where a portion of information in the first RAW image is lost due to the image processing that is applied in step S101. For example, consider a case in which noise reduction processing for reducing noise in the first RAW image and thereby improving the image quality of the first RAW image is applied in step S101. The noise reduction processing is image smoothing or low-pass filtering processing. High-frequency components that are removed from the first RAW image by performing the noise reduction processing may include not only noise components but also original high-frequency components of the image, resulting in a decrease in the sharpness.

The apparatus that generates a second RAW image (the image capture apparatus 100 or the first image processing system 20, hereinafter, the image capture apparatus 100) normally possesses detailed knowledge related to the development process that is applied using the dedicated application. For this reason, the apparatus that generates a second RAW image is capable of estimating the content and extent of image quality improvement processing that is applied in the development process that is performed using the dedicated application, when generating a second RAW image. On the other hand, the apparatus that generates a second RAW image is incapable of estimating the intensity of image quality improvement processing that is applied in the development process that is performed using the general-purpose application.

For this reason, in step S100, the image capture apparatus 100 (the system control unit 5) varies the settings of image processing that is applied to the first RAW image by the image processing circuit or processor 4 between:

a first case where a RAW image file of a file type (manufacturer-specific type) designed for a development process that is performed using a dedicated application is generated, and

a second case where a RAW image file of a file type designed for a development process that is performed using a general-purpose application. In a case where the image processing that is applied to the first RAW image is noise reduction processing, for example, the image capture apparatus 100 (the system control unit 5) varies the settings of the intensity of the noise reduction processing, for example.

For example, in the first case, improvement in the sharpness at the time of the development process may be expected, and thus the system control unit 5 may set a higher intensity of noise reduction processing than in the second case for which the content and extent of the development process cannot be estimated.

Alternatively, in the second case for which the content and extent of the development process cannot be estimated, there is the possibility that the noise reduction processing is not performed at the time of the development process, and thus, the system control unit 5 sets the intensity higher than in the first case such that the effect of the noise reduction processing is reliably achieved.

Which case is preferred may dynamically differ according to the user, use of the image, and the like, and thus the system control unit 5 may perform setting of image processing in accordance with user settings and a file type.

The intensity of the noise reduction processing may be adjusted, for example, based on the amount of high frequency components to be added in texture correction that is performed on the RAW image subjected to the noise reduction processing. The image processing circuit or processor 4 may obtain high frequency components removed during the noise reduction processing, for example, by taking the difference between the first RAW image before the noise reduction processing and the second RAW image after the processing. The texture correction is processing for adjusting the sharpness or the noise amount by adding (returning) a portion of the high frequency components removed during the noise reduction processing to the second RAW image. Due to the texture correction, the effect of the noise reduction processing may be virtually decreased. The system control unit 5 may control the intensity of the noise reduction processing, for example, by the image processing circuit or processor 4 controlling the ratio of high frequency components to be added to the second RAW image through the texture correction. Note that, i an intensity parameter may be set in the noise reduction processing that is applied by the image processing circuit or processor 4, the system control unit 5 may control the intensity of the noise reduction processing by controlling the intensity parameter.

In addition, the system control unit 5 may determine whether or not to store the first RAW image in the RAW image file, in accordance with whether the processing is in the first case or the second case. Specifically, a configuration may be adopted in which the system control unit 5 stores the first RAW image in the RAW image file in the first case, and does not store the first RAW image in the RAW image file in the second case.

Alternatively, a configuration may also be adopted in which, in the first case, and in a case where the dedicated application may use the first RAW image at the time of the development process, the system control unit 5 stores the first RAW image in the RAW image file .

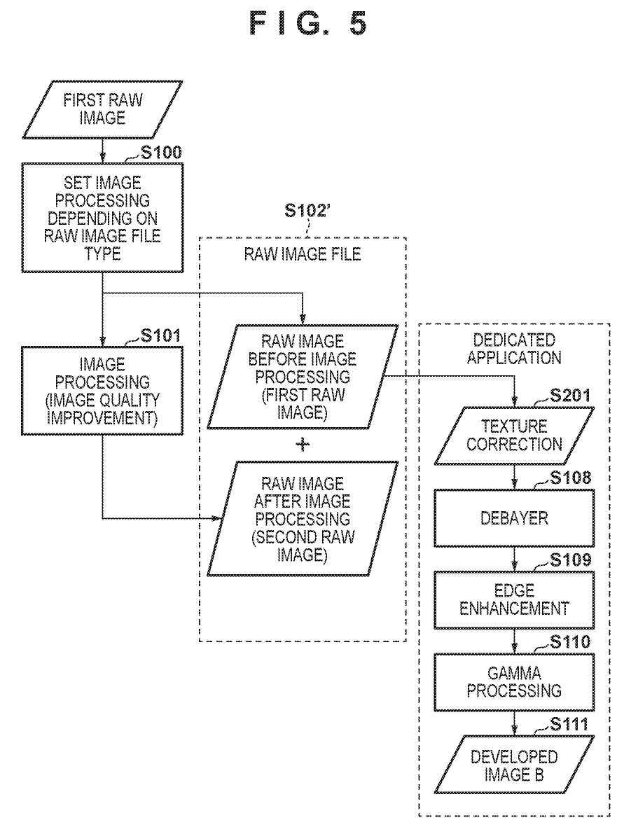

FIG. 5 is a flowchart showing a series of processing, in which the system control unit 5 generates a RAW image file of a manufacturer-specific type containing a first RAW image, and performs a development process on the generated RAW image file using a dedicated application.

Steps S100 and S101 are the same as those in FIG. 4. In step S102’, the system control unit 5 generates a RAW image file of a manufacturer-specific type containing a RAW image (first RAW image) before the image processing is applied in step S101 and a RAW image (second RAW image) to which the image processing was applied in step S101. The system control unit 5 stores the RAW image file in the recording medium 10.

Steps S201 and S108 to S111 represent, for example, processing that is performed by the second image processing system 22 (the CPU 405) executing a dedicated application. First, the CPU 405 reads out the first RAW image and the second RAW image from the RAW image file stored in the recording medium 10, and loads the images to the RAM 407.

The CPU 405 then applies texture correction to the second RAW image using the first RAW image and the second RAW image. The texture correction may be performed using the same algorithm as the image processing circuit or processor 4 of the image capture apparatus 100, which makes it possible to suppress the difference from a developed image obtained by the image capture apparatus 100. The intensity of the texture correction in step S201 may be fixed, or may be determined through interaction with the user. That is to say, the user may repeatedly set the intensity of the texture correction and confirm the result of the setting through a GUI screen provided by the dedicated application, to determine a final intensity of the texture correction. Note that processing of steps S201 to S110 in the dedicated application may be performed in any order, and the same processing may be repeatedly performed in accordance with a user’s instruction. Therefore, the user may readjust the intensity of the texture correction based on the results of the edge enhancement (sharpness) processing in step S109 and the gamma processing in step S110.

Note that, even in cases where the image processing applied to the first RAW image is processing other than the noise reduction processing, such as optical aberration correction or demosaicing processing, the settings may be changed according to a file type, as in the case of the noise reduction processing. Specifically, in the case of optical aberration correction, the intensity of correction may be changed, and in the case of demosaicing processing, the interpolation method (e.g., the number or type of near pixels used for interpolation) may be changed.

As described above, according to at least one embodiment, settings of image processing to be applied to a RAW image to be stored in a RAW image file to be generated vary according to the file type of the RAW image file. For this reason, it is possible to apply image processing in consideration of the differences in capabilities between applications that are used for a development process, and are each designed for a file type, and it is possible to increase the likelihood of achieving an intended developed image using various development process applications.

### Modified Example

In a case where a dedicated application also supports a development process of a RAW image file of a general-purpose type, the content of the development process may be changed according to a type of RAW image file to be subjected to the development process.

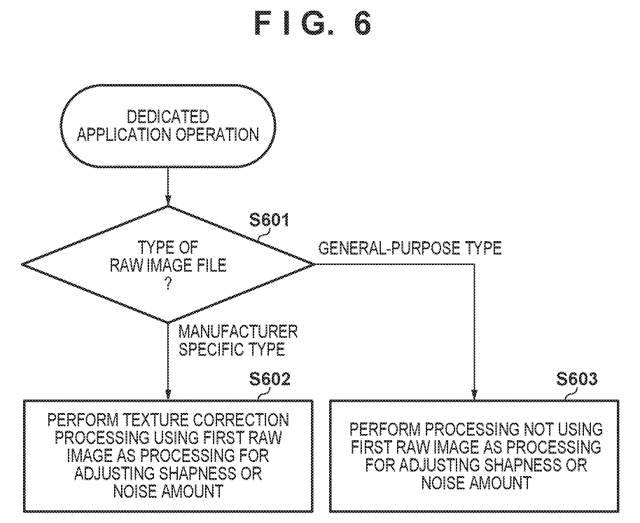

For example, consider a case where a RAW image file of a manufacturer-specific type contains a first RAW image, and a RAW image file of a general-purpose type does not contain a first RAW image. In this case, the CPU 405 that executes a dedicated application may execute processing illustrated in the flowchart in FIG. 6.

In step S601, the CPU 405 determines whether a RAW image file to be subjected to the development process is of a manufacturer-specific type or a general-purpose type. This determination may be performed, for example, based on the file extension. The CPU 405 executes step S602 if it is determined that the RAW image file to be subjected to the development process is of the manufacturer-specific type, and executes S603 if it is determined that the RAW image file is of the general-purpose type.,

In step S602, the CPU 405 determines that texture correction processing that uses a first RAW image is to be performed as processing for adjusting the sharpness or the noise amount that is performed in the development process.

In step S603, the CPU 405 determines that processing that does not use the first RAW image (such as dithering processing) is to be performed as processing for adjusting the sharpness or the noise amount that is performed in the development process.

Note that, even in a case where the RAW image file of the manufacturer-specific type does not include the first RAW image, it is possible to change the content of the development process according to the type of the RAW image file to be subjected to the development process.

Although, here, an example has been described in which the content of processing for adjusting the sharpness or the noise amount that is performed at the time of the development process is changed, the content of other processing may also be changed. For example, algorithms of debayer processing, edge enhancement processing, gamma processing, and the like may also be changed. Specifically, an algorithm similar to that of the development process that is executed by the image capture apparatus is used in the case of a manufacturer-specific type, while a different algorithm is used in the case of a general-purpose type.

### Other Embodiments

Embodiment(s) of the present disclosure may also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-139974, filed August 21, 2024, which is hereby incorporated by reference herein in its entirety.

What is claimed is:

1. An image processing apparatus comprising:
one or more processors that operate to:
apply image processing to a first RAW image to generate a second RAW image;
generate a RAW image file that contains the second RAW image as a file of one of a plurality of types that include a first type and a second type; and
control an operation of the image processing,
wherein the control varies a setting of the image processing between a case where a RAW image file of the first type is generated and a case where a RAW image file of the second type is generated.

2. The image processing apparatus according to claim 1,
wherein the image processing is image processing for improving image quality.

3. The image processing apparatus according to claim 1,
wherein the image processing includes at least one of noise reduction processing, processing for correcting an effect of aberration of a lens used for capturing the first RAW image, and debayer processing.

4. The image processing apparatus according to claim 3,
wherein the image processing includes the debayer processing.

5. The image processing apparatus according to claim 3,
wherein the image processing does not include the debayer processing.

6. The image processing apparatus according to claim 1,
wherein the one or more processors further operate to perform the control to vary a setting of an intensity of the image processing between a case where a RAW image file of the first type is generated and a case where a RAW image file of the second type is generated.

7. The image processing apparatus according to claim 1,
wherein the RAW image file of the first type contains the first RAW image, and the RAW image file of the second type does not contain the first RAW image.

8. The image processing apparatus according to claim 1,
wherein the RAW image file of the first type and the RAW image file of the second type contain the first RAW image.

9. The image processing apparatus according to claim 7,
wherein the one or more processors further operate to perform the control to cause an intensity of the image processing to be higher in a case where the RAW image file of the first type is generated than in a case where the RAW image file of the second type is generated.

10. The image processing apparatus according to claim 7,
wherein the one or more processors further operate to perform the control to cause an intensity of the image processing to be lower in a case where the RAW image file of the first type is generated than in a case where the RAW image file of the second type is generated.

11. The image processing apparatus according to claim 1,
wherein a type of RAW image file that is generated is determined in accordance with user settings.

12. The image processing apparatus according to claim 1,
wherein the image processing apparatus is an image capture apparatus that generates the first RAW image.

13. An image processing apparatus comprising:
one or more processors that operate to:
obtain a RAW image file; and
apply a development process to a RAW image contained in the RAW image file,
wherein the one or more processors vary the development process that is applied to the RAW image according to a type of RAW image file.

14. The image processing apparatus according to claim 13,
wherein, in a case where the RAW image file includes both a first RAW image and a second RAW image obtained by applying image processing to the first RAW image, the one or more processors apply processing that uses the first RAW image in a development process of the second RAW image.

15. The image processing apparatus according to claim 14,
wherein the processing that uses the first RAW image is processing for adjusting sharpness or a noise amount.

16. An image processing method comprising:
generating a second RAW image by applying image processing on a first RAW image;
generating a RAW image file of one of a plurality of types that include a first type and a second type, the RAW image file containing the second RAW image; and
varying a setting of the image processing between a case where a RAW image file of the first type is generated and a case where a RAW image file of the second type is generated in the generating of the RAW image file.

17. An image processing method comprising:
obtaining a RAW image file; and
applying a development process to a RAW image contained in the RAW image file,
wherein, the applying varies the development process according to a type of the RAW image file.

18. A non-transitory computer-readable medium that stores a program for causing a computer to execute the image processing an image processing method comprising:
generating a second RAW image by applying image processing on a first RAW image;
generating a RAW image file of one of a plurality of types that include a first type and a second type, the RAW image file containing the second RAW image; and
varying a setting of the image processing between a case where a RAW image file of the first type is generated and a case where a RAW image file of the second type is generated in the generating of the RAW image file.

19. A non-transitory computer-readable medium that stores a program for causing a computer to execute an image processing method comprising:
obtaining a RAW image file; and
applying a development process to a RAW image contained in the RAW image file,
wherein the applying varies the development process according to a type of the RAW image file.
